(19) United States
(12) Patent Application Publication
(10) Pub. No.: US 2004/0008174 A1
(43) Pub. Date: Jan. 15, 2004

(54) Graphics controller configurable for any display device

(76) Inventor: Denis Beaudoin, Surrey (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/194,087

(22) Filed: Jul. 12, 2002

(51) Int. Cl. G09G 3/36

(52) U.S. Cl. 345/100

(57) ABSTRACT

A graphics controller configurable for any display device. The graphics controller includes a clock, a counter, and a memory for storing a timing scan pattern. The timing scan pattern is a representation of the timing signals according to the protocol required for a particular display. The timing scan pattern is stored at a plurality of addresses in the memory. The counter is coupled to an address input of the memory. In response to a clock pulse, the count value increments causing a like increment in a selected memory address. The content of the memory at each selected address is provided to the graphics display device. The graphics controller can be configured for use with different display devices by storing different timing scan patterns in the memory.

### BACKGROUND OF THE INVENTION

### FIELD OF THE INVENTION

The present invention relates generally to video display controllers, and more particularly to a graphics controller configurable for any display device.

In a Liquid Crystal Display (“LCD”), the pixels must be periodically refreshed in order to display an image and to change the displayed image. In each refresh cycle, a graphics controller sends a new array of pixel data (a “frame”) to the LCD and asserts various signals according to a specific protocol. Within certain segments of the LCD market, the required timing signals are unique to specific types, brands, and models of display devices.

Typically, graphics controllers include a counter-decoder circuit to generate the timing signals. Because the counter-decoder circuit includes a decode logic circuit that is hardwired, different types, brands, and models of display devices, such as LCDs, generally require different graphics controllers. This can be a particular problem if there is a need for the flexibility to use a new type, brand, or model of display device in an existing product. In the case of portable devices, such as hand-held organizers, cellular telephones, digital cameras, and digital video cameras, it may be advantageous to change the display type if the display type formerly used is no longer available or if a superior or less expensive display type becomes available. However, changing the type of display device requires a new graphics controller. In addition, it is often necessary to redesign the product to accommodate the new graphics controller.

A variation on the typical prior art graphics controller employs two hardwired decode logic circuits instead of one. Each decode logic circuit produces timing signals for a different type of display device. A multiplexer is used to select the decode logic circuit that is appropriate for the type of display device used in the product. While it is recognized in the art that additional flexibility can be obtained by adding decode logic circuits and a larger multiplexer, this approach does not address the problem of accommodating display device types that were not anticipated at the time the graphics controller was designed.

Accordingly, there is a need for a graphics controller configurable for any display device.

### SUMMARY OF THE INVENTION

The invention disclosed herein is a graphics controller configurable for any display device. The graphics controller includes a clock, a counter, and a memory for storing a timing scan pattern. The timing scan pattern is a representation of the timing signals according to the protocol required for a particular display device. The timing scan pattern has a particular length and is stored at a plurality of addresses in the memory. The clock is coupled with and provides a clock signal to the counter. The output from the counter is a count value that is coupled to an address input of the memory. In response to a clock pulse, the count value increments causing a like increment in a selected memory address. The content of the memory at each selected address is provided to the graphics display device. The counter counts from an address where the timing scan pattern begins to where it ends. Through a sequence of clock pulses, a timing scan pattern is thus provided to the graphics display device.

The count sequence is repeated for each refresh cycle. In one preferred embodiment, the counter is coupled to a register for storing a start value for the count sequence. The start value is read from the register and reloaded in the counter at the beginning of each refresh cycle. In addition, after a count sequence is complete, the start value is read from the register and stored in the counter. In this manner, the counter repeatedly cycles through the count sequence and, thereby, repeatedly provides the timing scan pattern to the graphics display device.

The graphics controller can be configured for use with different display devices by storing different timing scan patterns in the memory.

In an alternative preferred embodiment, the graphics controller further comprises horizontal and vertical paths. The horizontal path is for generating a horizontal timing scan pattern and comprises a first register, a first counter, and a first memory. The vertical path is for generating a vertical timing scan pattern and comprises a second register, a second counter, and a second memory.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a block diagram illustrating an exemplary prior art computer system including a CPU, a graphics controller, including a counter-decoder circuit within the graphics controller, and a display device.

FIG. 2 is a block diagram illustrating functional blocks within the counter-decoder circuit of FIG. 1.

FIG. 3 is a block diagram illustrating functional blocks within a second counter-decoder circuit that may be used within the graphics controller of FIG. 1.

FIG. 4 illustrates a diagram showing the positional layout of a timing scan pattern.

FIG. 5 is a block diagram illustrating an exemplary computer system including a CPU, a graphics controller according to the present invention, including a counter-decoder circuit within the graphics controller, and a display device.

FIG. 6 is a block diagram illustrating functional blocks within the counter-decoder circuit of FIG. 5.

### DESCRIPTION OF THE PREFERRED EMBODIMENTS

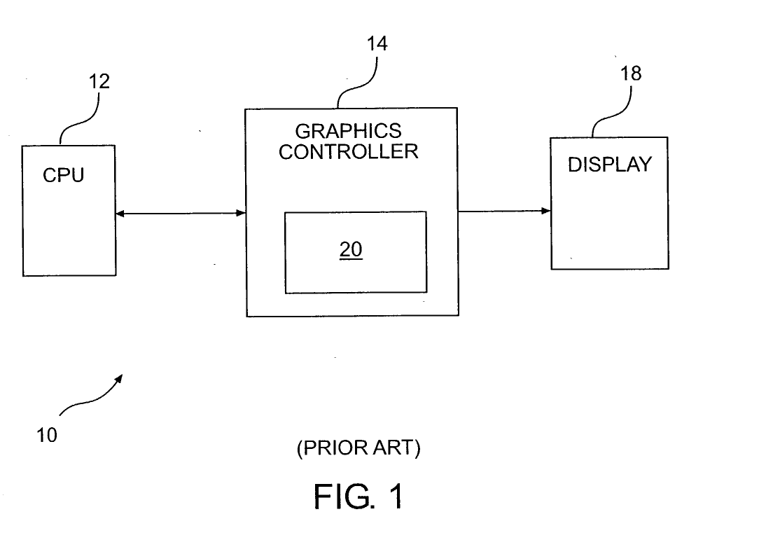

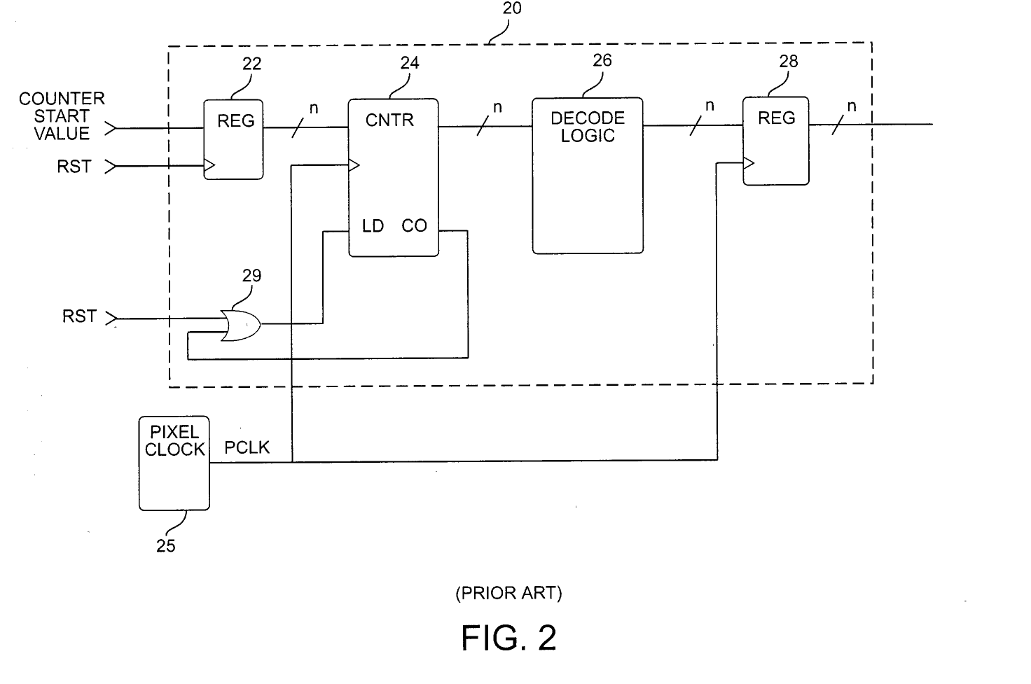

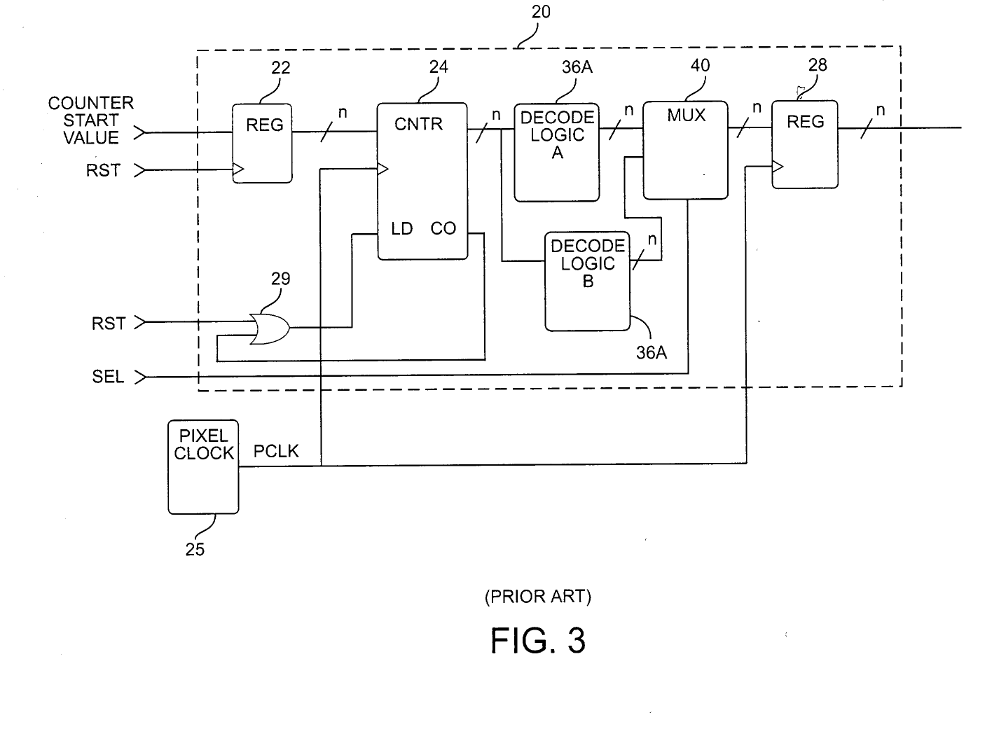

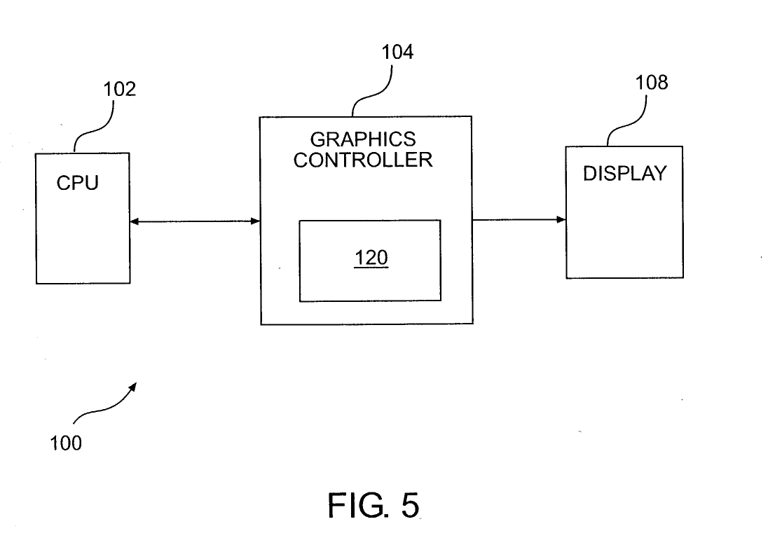

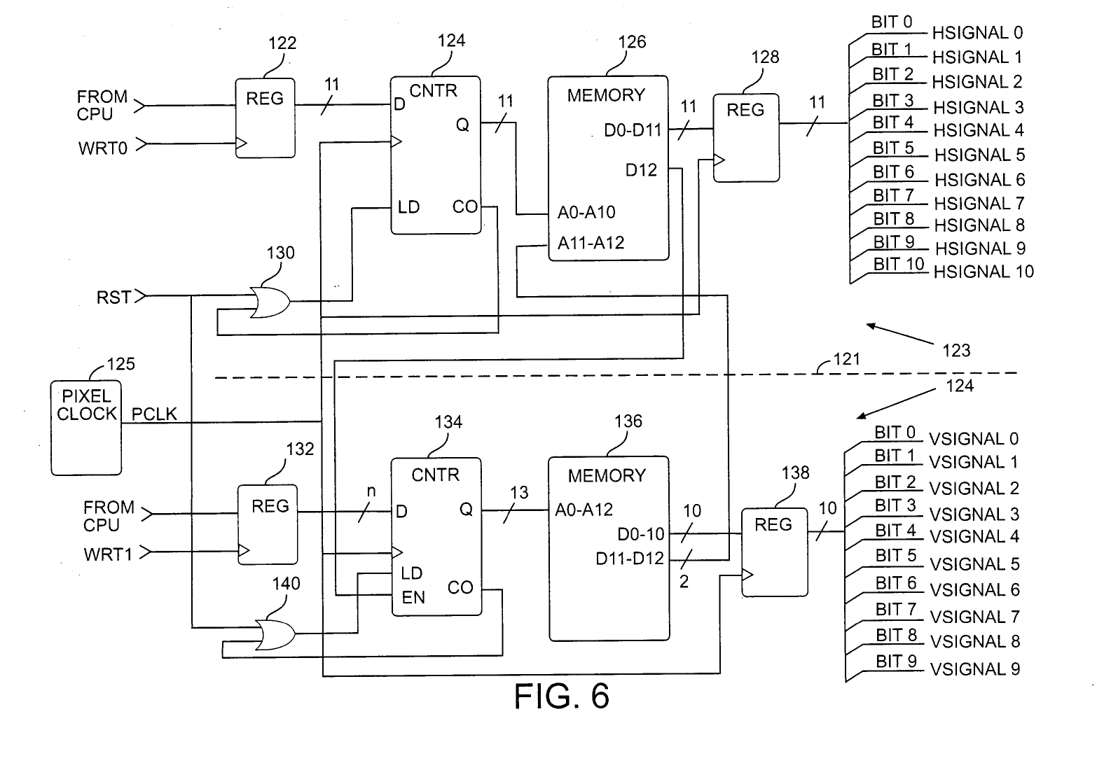

Prior to discussing the present invention, an exemplary prior art computer system such as that shown in FIG. 1, exemplary prior art counter-decoder circuits such as those shown in FIGS. 2-3, and an exemplary prior art timing scan pattern will be discussed. Then, the present invention will be discussed in detail with reference to FIGS. 5-6.

FIG. 1 illustrates a prior art computer system, indicated generally by reference number 10, for interfacing a CPU 12 to a display device 18, such as an LCD, using a graphics controller 14. The CPU 12 provides graphics display information (that may include pixel data) to the graphics controller 14. The graphics controller 14 processes the graphics display information and provides the display device 18 with pixel data. The graphics controller 14 includes a typical prior art counter-decoder circuit 20 to generate the timing signals required by the display device 18. As explained below, the graphics controller 14 may include alternate counter-decoder circuits.

FIG. 2 illustrates counter-decoder circuit 20 that comprises a register 22, a counter 24, a decode logic circuit 26, a register 28, and an OR gate 29. A counter start value is stored in register 22. A reset signal RST is asserted to load the counter start value from the register 22 into the counter 24. The counter 24 counts from the counter start value up to a predetermined value, with the count value being incremented on each pulse of a signal PCLK from a pixel clock 25. The counter 24 asserts a carry-out signal CO when the count value reaches the predetermined value. The carry-out signal CO causes the start value in register 22 to be reloaded into the counter 24. On the next pulse of the pixel clock, a new count sequence begins. The output of counter 24 is coupled to a decode logic circuit 26. The decode logic circuit 26 is made up of a number of basic logic gates and is designed to produce the control signals required by the display device 18. The decode logic circuit 26 is coupled to an output register 28. The display device 18 is coupled with and receives control signals from the output register 28.

FIG. 3 illustrates a second typical prior art counter-decoder circuit 30 that is able to control two types of display devices. The counter-decoder circuit 30 may be used in place of the counter-decoder circuit 20 in graphics controller 14. The counter-decoder circuit 30 includes certain elements that are identical to those contained in counter-decoder circuit 20 and like elements are denoted by like reference numbers. The counter-decoder circuit 30 includes a register 22, a counter 24, and a register 28. The counter-decoder circuit 30 operates in the same manner as counter-decoder circuit 20, except that output of counter 24 is decoded by two decode logic circuits 36A, 36B. Each decode logic circuit 36A, 36B produces control signals for a different type of display device. A select signal SEL is used to control a multiplexer 40 that is used to select the appropriate control signals for the type of display device in use.

The phrase “timing scan pattern” is used hereinafter to mean the timing signals that a graphics controller repetitively sends to a display device in each refresh cycle. Typically, a timing scan pattern includes a Frame Pulse signal, a Line Pulse signal, as well as a plurality of other signals. The Frame Pulse signal provides an indication to the display device that a new frame has started. The Line Pulse signal provides an indication to the display device that a new line within the frame has started.

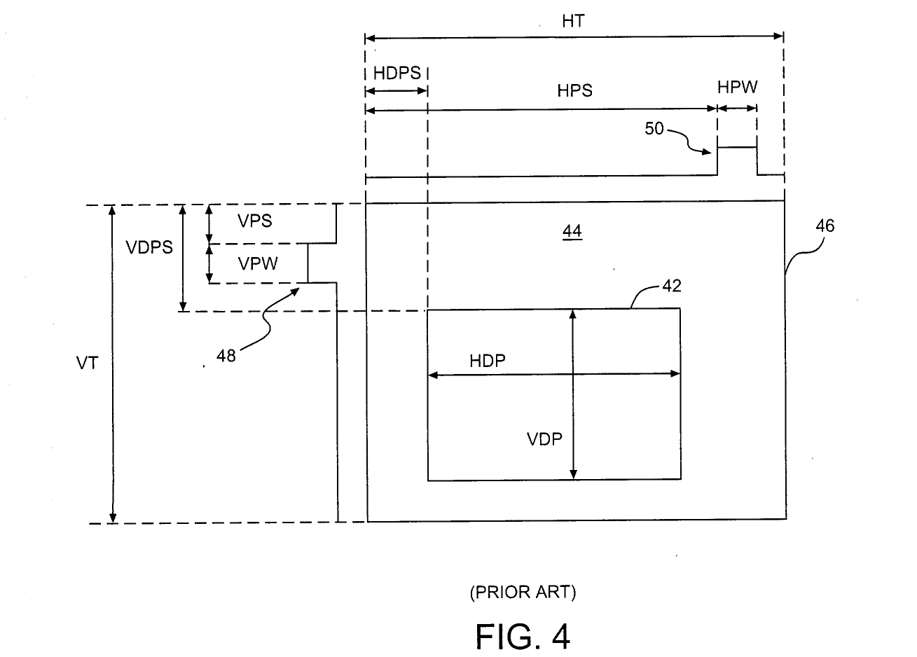

Referring to FIG. 4, a diagram of the positional layout of a typical timing scan pattern is illustrated. The time required to traverse each horizontal line within the timing scan pattern is the horizontal time HT. Similarly, the time required to traverse the timing scan pattern vertically is the vertical time VT. Within a first defined portion 42 of the timing scan pattern, a frame of pixel data is written to the display device. With respect to the first defined portion 42, the time required to traverse each horizontal line on the display device is the horizontal display period HDP. Similarly, the time required to traverse the display device vertically is the vertical display period VDP. The location where pixel data is first written to the display device is defined by the horizontal display period start position and the vertical display period start position, HDPS and VDPS, respectively. Within a second defined portion 44 of the timing scan pattern, control signals are asserted and de-asserted. This second defined portion 44 is anywhere outside the first defined portion 42 that is within the VT-HT boundary 46. In the timing scan pattern of FIG. 4, an exemplary Frame Pulse 48 and an exemplary Line Pulse 50 are shown. The location where the Frame Pulse 48 is asserted is defined by the frame pulse start position VPS, and the duration of the Frame Pulse 48 is defined by the frame pulse width VPW. Similarly, the location where the Line Pulse 50 is asserted is defined by the line pulse start position HPS, and the duration of the Line Pulse 50 is defined by the line pulse width HPW.

As shown in FIG. 4, a typical timing scan pattern has a horizontal component (“horizontal timing scan pattern”) and a vertical component (“vertical timing scan pattern”). The Frame Pulse 48 can be viewed as being part of the vertical component. The vertical component of a timing scan pattern can include additional control signals. The Line Pulse 50 can be viewed as being part of the horizontal component of the timing scan pattern. The horizontal component of a timing scan pattern can include additional control signals. The frame of pixel data written to the display device within the first defined portion 42 is not considered part of a timing scan pattern. However, “dummy” pixel data may be written to the display device within the second defined portion 44 as part of the timing scan pattern. Dummy pixel data written to the display device within the second defined portion 44 is used for control purposes and may be considered part of either the vertical or horizontal component of a timing scan pattern.

The Frame Pulse 48 and Line Pulse 50 signals may be defined at other locations and for various durations within the timing scan pattern. For example, the Line Pulse 50 could occur at the start of a line before the HDP begins. In addition, other signals than those shown may be included with a timing scan pattern. For example, the timing scan pattern may include control signals that tell the display device which field is being refreshed in an interlacing scheme. Further, the timing scan pattern may include periods when control signals are not asserted. For example, at the end of a horizontal line, a display device may require a “blanking period” before the device is able to refresh the next line. Without the required blanking period, pixel data would be sent to the display device before the display device was ready to receive it.

FIG. 5 illustrates a computer system according to the present invention, indicated generally by reference number 100, for interfacing a CPU 102 to a display device 108, such as an LCD, using a graphics controller 104 configurable for any display device. The CPU 102 provides graphics display information (that may include pixel data) to the graphics controller 104. The graphics controller 104 processes the graphics display information and provides the display device 108 with pixel data. The graphics controller 104 includes a counter-decoder circuit 120 to generate the timing signals required by the display device 108. The counter-decoder circuit may be located within a chip containing the graphics controller 104.

Referring now to FIG. 6, a counter-decoder circuit 120 according to the present invention is illustrated. In FIG. 6, the portion of the counter-decoder circuit 120 above dashed line 121 is referred to herein as the “horizontal path,” designated by reference numeral 123. The portion of the circuit 120 below the dashed line 121 is referred to herein as the “vertical path,” designated by reference numeral 124. The horizontal path 123 is adapted to generate a horizontal timing scan pattern. The vertical path 124 is adapted to generate a vertical timing scan pattern. Because the horizontal and vertical paths have symmetrical components and operate in a similar way, the operation of the counter-decoder circuit 120 will be described only with reference to the horizontal path 123.

To initialize the graphics controller 104 for operation, the CPU 102 stores a horizontal time HT start value in register 122. In addition, the CPU 102 stores a horizontal timing scan pattern in memory 126. The particular horizontal time HT start value that is stored in register 122 and the particular horizontal timing scan pattern that is stored in memory 126 are the appropriate value and appropriate pattern for the display device 108 in use. With each different type of display 108 that is used in computer system 100, a different horizontal time HT start value and a different horizontal timing scan pattern may be stored. For purposes of clarity, the couplings necessary to load the horizontal timing scan pattern into memory 126 are not shown. In one preferred embodiment, address and data inputs of memory 126 are coupled with the CPU 102 for the purposed of loading the horizontal timing scan pattern.

To begin operation, a reset signal, RST is asserted to load the horizontal time HT start value into counter 124. In the shown embodiment, the counter 124 is an 11 binary digit (“bit”) up-counter that counts from a HT start value up to 2047. In other embodiments, the counter 124 can have a smaller or larger number of bits. The count value is incremented on each pulse of a signal PCLK from a pixel clock 125. A carry-out signal CO is asserted by the counter 124 when the count value reaches 2047. The carry-out signal CO is coupled to the OR gate 130 and causes the horizontal time HT start value to be reloaded into the counter 124 so that a new horizontal count sequence begins. For example, if the horizontal time HT is 1047 pulses of the PCLK signal, a value of 1000 (2047−1047=1000) is placed in register 122 and the counter 124 will repeatedly count from 1000 up to 2047. In an alternative preferred embodiment, the counter 124 is a down-counter that counts down from a particular value to zero. In this alternative embodiment, a horizontal time HT end value is stored in register 122 and loaded into the counter 124 upon assertion of the output of the OR gate 130.

The output of the counter 124 is coupled to the address inputs of memory 126. The data output of memory 126 is coupled to an output register 128. In operation, as the counter 124 is incremented on each pulse of the pixel clock signal PCLK, the next sequential address in memory 126 is selected. If the contents of memory 126 at the selected address is a bit value indicating that the signal is asserted (such as a “1”), this bit value will be clocked into the output register 128 that is coupled with the display device 108. Similarly, if the contents of memory 126 at the selected address is a bit value indicating that the signal is not asserted (such as a “0”), this bit value will be clocked into the output register 128. To illustrate one example, if the horizontal time HT is 900, if the duration of the Line Pulse is 50 pulses of the signal PCLK, and if the counter 124 is an 11 bit up-counter, the 1047 memory locations that correspond to one particular line of the horizontal timing scan pattern would include: the bit value “0” in memory locations 1000 to 1899; the bit value “1” in memory locations 1900 to 1949; and the bit value “0” in memory locations 1950 to 2047.

As indicated above, the output register 128 is coupled with the display device 108. In the embodiment shown in FIG. 6, the output register 128 has 11 bits of output that correspond to eleven horizontal signals (HSIGNAL 0-HSIGNAL 10).

As mentioned above, the horizontal and vertical paths have symmetrical components and operate in a similar way. The vertical path 124 of counter-decoder circuit 120 includes a register 132, a counter 134, a memory 136, an output register 138, and an OR gate 140. To initialize the graphics controller 104 for operation, the CPU 102 stores a vertical time VT start value in register 132. In addition, the CPU 102 stores a vertical timing scan pattern for the display device 108 in use in memory 136. The particular vertical time VT start value and the particular vertical timing scan pattern that is stored in register 132 are the appropriate value and appropriate pattern for the display device 108 in use. With each different type of display 108 that is used in computer system 100, a different vertical time VT start value and a different vertical timing scan pattern may be stored. For purposes of clarity, the couplings necessary to load the vertical timing scan pattern into memory 136 are not shown, but such couplings are similar to those described above with reference to the horizontal scan path. In addition, in the embodiment shown in FIG. 6, the output register 138 has 10 bits of output that correspond to ten vertical signals (VSIGNAL 0-VSIGNAL 9).

The vertical and horizontal paths 123, 124 operate cooperatively. The D12 output data bit of memory 126 is coupled to the enable input EN of the counter 134. When the D12 output data bit of memory 126 is asserted, the counter 134 is enabled which in turn enables the vertical path 124. In addition, the D11 and D12 output data bits of memory 136 are coupled to the A11 and A12 address bits of the memory 126. When the D11 and D12 output data bits of memory 136 are asserted, memory locations within memory 126 are selected where no horizontal control signals are stored thus disabling the horizontal path.

A first advantage of the graphics controller 104 is that it can be reconfigured for use with any display device 108 simply by storing the appropriate start values and timing scan patterns in memory 126. Because the start values and timing scan patterns are stored in the memory 126 by the CPU 102, the graphics controller 104 can support a type of display device 108 that is contemplated after the graphics controller 104 has been manufactured.

A further advantage of the graphics controller 104 is that the development of a graphics controller chip is simpler and more efficient. There is no need to develop and test a large number of decode logic circuits (such as decode logic circuits 26, 36A, 36B) before the chip design is finalized. The timing scan patterns can be developed and tested after the chip is being manufactured based on any need to use a new type, brand, or model of display device 108. In addition, should a mistake in a timing scan pattern be detected, it can be corrected by storing a new timing scan pattern into memory 126.

While the memories 126, 136 are disclosed herein as 8K×12 bit memory arrays, it is contemplated that in other embodiments the memories 126, 136 could be made larger or smaller.

While the counter-decoder circuit 120 discloses two memories 126, 136 one for storing a horizontal timing scan pattern and the second for storing a vertical timing scan pattern, the present invention could be used with a timing scan pattern that requires 3 or more “channels.” In this case, the present invention would preferably include a memory for each channel. In the shown embodiment, control signals are asserted on pixel boundaries, however, in an alternative preferred embodiment, control signals may be asserted on any fractional pixel boundary. An example of a timing scan pattern requiring 3 channels is one in which controls signals are asserted on fractional pixel boundaries.

While the counter-decoder circuit 120 will typically be located within a graphics controller chip, it may be located within another chip, within a display device, as a stand-alone circuit, or in any other suitable location.

While the initialization of the graphics controller 104 for operation has been described in terms of a CPU 102 storing start values and timing scan patterns in registers 122, 132 and memories 126, 136, any other means for storing a value in a register or a memory may be used for storing start values and timing scan patterns. In one preferred embodiment, registers 122, 132 and memories 126, 136 are programmable read only memories, such as PROM, EPROM, EEPROM, Flash EPROM, or other similar types of memories that are programmed using techniques known or that become known in the art.

While the graphics controller 104 of the present invention is preferably used with a display device 108 that is an LCD, it may be used for controlling refresh cycles in any known type of display device 108, such as a CRT. In addition, it is contemplated that the graphics controller 104 could be used to control a printer or other input/output device.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A graphics controller configurable for any display device, comprising:
a clock for generating a clock signal;
a first counter; and
a first memory having the capacity to store, in respective memory locations therein, a sequence of bits defining a timing scan pattern for the display device, wherein said first counter is coupled with said first memory and with said clock, and wherein, in response to said clock signal, said first counter is adapted to incrementally select and transfer the contents of said memory locations to the display device thereby providing said timing scan pattern to the display device.

2. The graphics controller of claim 1, wherein said first memory is for storing a horizontal timing scan pattern, and further comprising a first register coupled with said first counter for storing a horizontal time value.

3. The graphics controller of claim 2, further comprising a second memory for storing a vertical timing scan pattern, a second counter coupled with said second memory, and a second register coupled with said second counter for storing a vertical time value.

4. A computer system, comprising:
a CPU;
a display device; and
a graphics controller configurable for any display device, including:
a clock for generating a clock signal;
a first counter; and
a first memory having the capacity to store, in respective memory locations therein, a sequence of bits defining a timing scan pattern for the display device, wherein said first counter is coupled with said first memory and with said clock, and wherein, in response to said clock signal, said first counter is adapted to incrementally select and transfer the contents of said memory locations to the display device thereby providing said timing scan pattern to the display device.

5. The computer system of claim 4, wherein said first memory is for storing a horizontal timing scan pattern, and further comprising a first register coupled with said first counter for storing a horizontal time value.

6. The computer system of claim 5, further comprising a second memory for storing a vertical timing scan pattern, a second counter coupled with said second memory, and a second register coupled with said second counter for storing a vertical time value.

7. A method for refreshing an image on a display device, comprising:
providing a clock for generating a clock signal;
providing a first counter; and
providing a first memory having the capacity to store, in respective memory locations therein, a sequence of bits defining a timing scan pattern for the display device, wherein said first counter is coupled with said first memory and with said clock, and wherein, in response to said clock signal, said first counter is adapted to incrementally select and transfer the contents of said memory locations to the display device thereby providing said timing scan pattern to the display device.

8. The method for refreshing an image of claim 7, wherein said first memory is for storing a horizontal timing scan pattern, and further comprising:
providing a first register coupled with said first counter for storing a horizontal time start value.

9. The method for refreshing an image of claim 8, further comprising:
providing a second memory for storing a vertical timing scan pattern;
providing a second counter coupled with said second memory; and
providing a second register coupled with said second counter for storing a vertical time value.

10. A machine readable medium embodying a program of instructions executable by the machine to perform a method for refreshing an image on a display device, the method for refreshing an image comprising:
providing a clock for generating a clock signal;
providing a first counter; and
providing a first memory having the capacity to store, in respective memory locations therein, a sequence of bits defining a timing scan pattern for the display device, wherein said first counter is coupled with said first memory and with said clock, and wherein, in response to said clock signal, said first counter is adapted to incrementally select and transfer the contents of said memory locations to the display device thereby providing said timing scan pattern to the display device.

11. The medium of claim 10, wherein said first memory is for storing a horizontal timing scan pattern, and said method for refreshing an image further comprises:
providing a first register coupled with said first counter for storing a horizontal time value.

12. The medium of claim 11, wherein said method for refreshing an image further comprises:
providing a second memory for storing a vertical timing scan pattern;
providing a second counter coupled with said second memory; and
providing a second register coupled with said second counter for storing a vertical time value.
